(19) United States
(12) Patent Application Publication
(10) Pub. No.: US 2020/0125030 A1
(43) Pub. Date: Apr. 23, 2020

(54) INFORMATION PROCESSING APPARATUS, INFORMATION PROCESSING METHOD, PROGRAM, AND CELL OBSERVATION SYSTEM

(71) Applicant: SONY CORPORATION, TOKYO (JP)

(72) Inventors: TAKESHI KUNIHIRO, KANAGAWA (JP); HIROKAZU TATSUTA, KANAGAWA (JP)

(21) Appl. No.: 16/627,549

(22) PCT Filed: May 11, 2018
(86) PCT No.: PCT/JP2018/018350

§ 371 Date: Dec. 30, 2019

(30) Foreign Application Priority Data
Jul. 10, 2017 (JP) 2017-134742

(51) Int. Cl. G03H 1/02; G03H 1/22; G03H 1/00; G03H 1/18; G06T 7/00

(52) U.S. Cl. CPC G03H 1/02; G03H 1/22; G03H 1/0005; G06T 2207/30024; G06T 7/0012; G03H 2001/005; G03H 2001/0212; G03H 1/181

(57) ABSTRACT

An information processing apparatus according to an embodiment of the present technology includes: a calculation unit; and an amplitude replacement unit. The calculation unit repeatedly executes first light propagation calculation for propagating, from a sensor surface of an image sensor to a support surface that supports a cell to be observed, a first complex amplitude distribution that includes a light intensity distribution of a hologram of the cell obtained on the sensor surface, and second light propagation calculation for propagating, from the support surface to the sensor surface, a second complex amplitude distribution obtained as a result of the first light propagation calculation. The amplitude replacement unit replaces, in the second light propagation calculation, an amplitude component of the second complex amplitude distribution with a predetermined representative amplitude value at least once.

### TECHNICAL FIELD

The present technology relates to an information processing apparatus, an information processing method, a program, and a cell observation system that are capable of reconstructing an image of a cell from a hologram.

### BACKGROUND ART

A phase-contrast microscope that is generally used as a microscope for observing a cell needs Koehler illumination for illumination and a magnifying optical system for observation, which makes the system large, and costs a lot. For this reason, in recent years, a lensless microscope including only a light source and a general image sensor has attracted attention.

The lensless microscope has an in-line hologram as a basic principle, and is capable of reconstructing an image of an object from an imaged hologram by calculation. However, in such an in-line hologram, since the above-mentioned image sensor is capable of recording only information (square value of the amplitude) regarding a light intensity, it is necessary to recover information regarding the light phase in order to acquire a reconstructed image of the object.

As a method of recovering information regarding the hologram phase, an iterative phase retrieval method in which the phase information is recovered by repeating propagation with a plurality of holograms imaged at different wavelengths as restraint conditions has been reported (e.g., Non-Patent Literature 1).

### CITATION LIST

### Non-Patent Literature

Non-Patent Literature 1: A. Lambrechts, “Lens-free digital in-line holographic imaging for wide field-of-view, high resolution and real-time monitoring of complex microscopic objects”, Proc. of SPIE, Vol. 8947, 2014

### DISCLOSURE OF INVENTION

### Technical Problem

However, even with the technology described in Non-Patent Literature 1, there is a problem that the information regarding the hologram phase cannot be sufficiently recovered and artifacts of the reconstructed image cannot be completely removed.

In view of the circumstances as described above, it is an object of the present technology to provide an information processing apparatus, an information processing method, a program, and a cell observation system that are capable of correctly recovering information regarding a hologram phase and reducing artifacts of a reconstructed image.

### Solution to Problem

In order to achieve the above-mentioned object, an information processing apparatus according to an embodiment of the present technology includes: a calculation unit; and an amplitude replacement unit.

The calculation unit repeatedly executes first light propagation calculation for propagating, from a sensor surface of an image sensor to a support surface that supports a cell to be observed, a first complex amplitude distribution that includes a light intensity distribution of a hologram of the cell obtained on the sensor surface, and second light propagation calculation for propagating, from the support surface to the sensor surface, a second complex amplitude distribution obtained as a result of the first light propagation calculation.

The amplitude replacement unit replaces, in the second light propagation calculation, an amplitude component of the second complex amplitude distribution with a predetermined representative amplitude value at least once.

As a result, the phase component of the complex amplitude distribution of the hologram is appropriately updated, and it is possible to acquire a reconstructed image of the cell in which the phase component has been sufficiently retrieved. That is, it is possible to reconstruct the sample surface from the defocused hologram.

The amplitude replacement unit may replace an amplitude component of the first complex amplitude distribution with an amplitude component of a different hologram acquired under a different imaging condition every time the first light propagation calculation is executed.

As a result, the frequency of restraining the amplitude component of the first complex amplitude distribution increases, and the number of times the propagation calculation necessary for phase retrieval is executed is reduced.

The different hologram may be one of a plurality of holograms having different wavelengths of the illumination light.

The different hologram may be one of a plurality of holograms having different distances from the support surface.

The amplitude replacement unit may replace the amplitude component of the second complex amplitude distribution with the predetermined representative amplitude value every time the second light propagation calculation is executed.

The predetermined representative amplitude value may be an average value of complex amplitude distributions obtained as results of the first light propagation calculation.

As a result, the amplitude component of the complex amplitude distribution of the hologram is smoothed, and the calculation load is reduced.

The predetermined representative amplitude value may include a value obtained by multiplying the average value by a predetermined correction coefficient, and the amplitude replacement unit may cause the correction coefficient to differ for each pixel region.

As a result, the frequency of restraining the amplitude component of the second complex amplitude distribution is adjusted.

The predetermined representative amplitude value may include a value obtained by multiplying the average value by a predetermined correction coefficient, and the amplitude replacement unit may cause the correction coefficient to differ every time the second light propagation calculation is executed.

As a result, the frequency of restraining the amplitude component of the second complex amplitude distribution is adjusted.

In order to achieve the above-mentioned object, an information processing method according to an embodiment of the present technology includes:

repeatedly executing first light propagation calculation for propagating, from a sensor surface of an image sensor to a support surface that supports a cell to be observed, a first complex amplitude distribution that includes a light intensity distribution of a hologram of the cell obtained on the sensor surface, and second light propagation calculation for propagating, from the support surface to the sensor surface, a second complex amplitude distribution obtained as a result of the first light propagation calculation.

In the second light propagation calculation, an amplitude component of the second complex amplitude distribution is replaced with a predetermined representative amplitude value at least once.

In order to achieve the above-mentioned object, a program according to an embodiment of the present technology causes an information processing apparatus to execute the steps of:

repeatedly executing first light propagation calculation for propagating, from a sensor surface of an image sensor to a support surface that supports a cell to be observed, a first complex amplitude distribution that includes a light intensity distribution of a hologram of the cell obtained on the sensor surface, and second light propagation calculation for propagating, from the support surface to the sensor surface, a second complex amplitude distribution obtained as a result of the first light propagation calculation; and replacing, in the second light propagation calculation, an amplitude component of the second complex amplitude distribution with a predetermined representative amplitude value at least once.

In order to achieve the above-mentioned object, a cell observation system according to an embodiment of the present technology includes: a light source; a sample holder; an image sensor; and a reconfiguration processing unit.

The light source emits illumination light.

The sample holder has a support surface that supports a cell to be observed.

The image sensor has a sensor surface that receives a hologram generated by interference between transmitted light and diffracted light, the illumination light being separated by the cell into the transmitted light and the diffracted light.

The reconfiguration processing unit repeatedly executes first light propagation calculation for propagating, from the sensor surface to the support surface, a first complex amplitude distribution that includes a light intensity distribution of the hologram obtained on the sensor surface, and second light propagation calculation for propagating, from the support surface to the sensor surface, a second complex amplitude distribution obtained as a result of the first light propagation calculation, and replaces, in the second light propagation calculation, an amplitude component of the second complex amplitude distribution with a predetermined representative amplitude value at least once.

### BRIEF DESCRIPTION OF DRAWINGS

FIG. 1 is a schematic diagram showing a configuration example of a cell observation system according to a first embodiment of the present technology.

FIG. 2 is a flowchart showing an information processing method for an information processing apparatus according to the above-mentioned embodiment.

FIG. 3 is a block diagram showing a procedure until the cell observation system according to the above-mentioned embodiment acquires a reconstructed image of a cell.

FIG. 4 is a block diagram showing a procedure of pre-processing by a pre-processing unit in the above-mentioned embodiment.

FIG. 5 is a diagram showing calculation processing (algorithm) in iteration in an iterative phase retrieval method executed by a reconfiguration processing unit in the above-mentioned embodiment.

FIG. 6 is a block diagram showing a procedure of amplitude replacement processing by an amplitude replacement unit in the above-mentioned embodiment.

FIG. 7 is a block diagram showing a procedure of amplitude replacement processing by the amplitude replacement unit in the above-mentioned embodiment.

FIG. 8 is a diagram comparing the calculation results of an existing method and the iterative phase retrieval method in the above-mentioned embodiment.

FIG. 9 is a diagram comparing the calculation results of an existing method and the iterative phase retrieval method in the above-mentioned embodiment.

FIG. 10 is a diagram showing a reconstructed image of a cell acquired by the iterative phase retrieval method in the above-mentioned embodiment together with an image of a cell captured by a quantitative phase microscope.

FIG. 11 is a graph showing the phase values of the above-mentioned various images.

FIG. 12 is a diagram showing calculation processing (algorithm) in iteration in the iterative phase retrieval method executed by a reconfiguration processing unit in a second embodiment of the present technology.

FIG. 13 is a diagram showing calculation processing (algorithm) in iteration in the iterative phase retrieval method executed by a reconfiguration processing unit in a third embodiment of the present technology.

FIG. 14 is a block diagram showing a procedure of amplitude replacement processing by an amplitude replacement unit in a modified example of the present technology.

### MODE(S) FOR CARRYING OUT THE INVENTION

Hereinafter, embodiments of the present technology will be described with reference to the drawings.

### First Embodiment

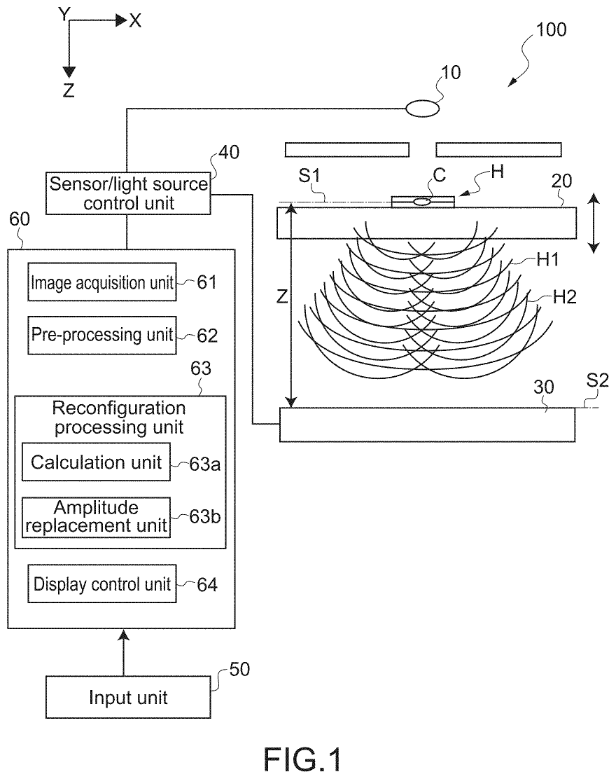

FIG. 1 is a schematic diagram showing a configuration example of a cell observation system 100 according to a first embodiment of the present technology.

As shown in FIG. 1, the cell observation system 100 includes a light source 10, an observation stage 20, an image sensor 30, a sensor/light source control unit 40, an input unit 50, and an information processing apparatus 60. Note that in FIG. 1, an X axis, a Y axis, and a Z axis orthogonal to each other are show.

The light source 10 is configured to be capable of applying, for example, illumination light having wavelengths (λ_{R}: 636 nm, λ_{G}: 515 nm, λ_{B}: 470 nm) corresponding to RGB to a cell C on the observation stage 20.

In the case where the illumination light from the light source 10 is applied to the cell C (observation target), this illumination light is divided into transmitted light and diffracted light. The transmitted light interferes with the diffracted light on the image sensor 30, thereby generating a hologram on the image sensor 30. The transmitted light can be referred to also as reference light for generating a hologram. This hologram (interference fringe) can be calculated on the basis of the Fresnel-Kirchhoff diffraction formula or Rayleigh-Sommerfeld diffraction formula (see formula (1)) described below.

The light source 10 in this embodiment is typically a partially coherent LED light source, but may be configured to increase temporal coherence by a band pass filter and spatial coherence by a pinhole.

The observation stage 20 supports a sample holder H that supports the cell C. The sample holder H has a support surface S1 that supports the cell C to be observed. The sample holder H is not particularly limited. However, the sample holder H is typically a preparation including a slide glass and a cover glass and has a light transmission property.

The observation stage 20 may be configured to be movable in the Z-axis direction. As a result, a distance Z between the support surface S1 and an image sensor surface S2 described below is adjusted, and the position of the image sensor 30 relative to the cell C can be adjusted.

The observation stage 20 has an area having a light transmission property, which causes the illumination light of the light source 10 to be transmitted therethrough, and the sample holder H is installed on this area. The area having a transmission property provided on the observation stage 20 may be formed of glass or the like, and may include an opening that communicates the upper and lower surfaces of the observation stage 20 in the Z-axis direction.

Note that although the cell C is employed as an object of the cell observation system 100 in this embodiment, the present technology is not limited thereto. For example, all of those derived from living bodies, such as a tissue, a sperm, a fertilized egg, a microorganism, may be employed as the object.

The image sensor 30 records the hologram of the cell C generated on the image sensor surface S2, and outputs image data regarding this hologram to the information processing apparatus 60. The image sensor 30 is, for example, a general image sensor such as a CCD sensor and a CMOS sensor. For this reason, in the recorded hologram on the image sensor surface S2, only a light intensity distribution (square value of amplitude) is recorded. Note that the image sensor surface S2 is a light reception surface that receives the hologram of the cell C.

The sensor/light source control unit 40 is connected to the light source 10 and the image sensor 30 wirelessly or by wire, and configured to be capable of controlling them. The sensor/light source control unit 40 controls the light source 10, and thus, the wavelength of illumination light to be applied to the cell C is switched, for example.

The input unit 50 is an operation device that inputs, to the information processing apparatus 60, operation information by a user. The input unit 50 may be an operation device such as a keyboard and a mouse, a touch panel, or the like.

The information processing apparatus 60 includes hardware necessary for a computer, such as a CPU (Central Processing Unit), a ROM (Read Only Memory), a RAM (Random Access Memory), and an HDD (Hard Disk Drive). The CPU loads the program according to the present technology stored in the ROM or HDD into the RAM and executes it, thereby executing an iterative phase retrieval method for the information processing apparatus 60 described below.

The program is installed in the information processing apparatus 60 via, for example, various storage media (internal memory). Alternatively, the program may be installed via the Internet or the like. In this embodiment, as the information processing apparatus 60, for example, a PC (Personal Computer) or the like is used. However, another arbitrary computer may be used.

[Information Processing Apparatus]

The information processing apparatus 60 includes an image acquisition unit 61, a pre-processing unit 62, a reconfiguration processing unit 63, and a display control unit 64.

The image acquisition unit 61 acquires, from the image sensor surface S2 on which the image data of the plurality of holograms in which the cell C has been imaged under different conditions is recorded, the image data.

For example, in the case where the light source 10 individually applies illumination light having the wavelengths λ_{R}, λ_{G}, and λ_{B} to the cell C, image data regarding holograms g_{λR}, g_{λG}, and g_{λB} corresponding to the wavelengths is acquired.

Alternatively, in the case where the light source 10 applies illumination light having a predetermined wavelength A to the cell C, image data regarding various holograms g_{Z1}, g_{Z2}, and g_{Z3} recorded on the image sensor surface S2 at first to third positions Z1, Z2, and Z3, respectively, with respect to the cell C is acquired.

The pre-processing unit 62 performs various types of correction on the image data regarding the hologram output from the image acquisition unit 61 so that iterative processing in an iterative phase retrieval method described below is appropriately performed.

The reconfiguration processing unit 63 includes a calculation unit 63a and an amplitude replacement unit 63b. The reconfiguration processing unit 63 retrieves the phase component of the complex amplitude distribution relating to the hologram lost on the image sensor surface S2 by repeating propagation between the image sensor surface S2 and the support surface S1 with the hologram output from the pre-processing unit 62 as the restraint condition.

Specifically, the amplitude replacement unit 63b repeats replacement of the amplitude component while transitioning the hologram by the light wave propagation calculation by the calculation unit 63a, and thus the lost phase component is retrieved. At this time, the reconfiguration processing unit 63 repeatedly executes a cycle for replacing the amplitude component of the complex amplitude distribution of the hologram obtained from the result of the propagation calculation with the actually measured amplitude component so that only the phase component remains.

Here, the “propagation of the hologram” in this embodiment means executing light wave propagation calculation for calculating the complex amplitude distribution (g(x,y,0)) in the hologram of the propagation destination on the basis of the Rayleigh-Sommerfeld diffraction integral represented by the following formula (1) from the complex amplitude distribution (g(x,y,z)) in the hologram of the propagation source.

$$\begin{matrix} [ Math . 1 ] & \\ g ( x , y , 0 ) = \int \int g ( {x}^{′} , {y}^{′} , {z}^{′} ) \frac{exp ( i 2 π {r}^{′} {λ}^{- 1} )}{{r}^{′}} \frac{- z}{{r}^{′}} ( 1 / 2 π {r}^{′} + 1 / i λ ) dxdy \\ {r}^{′} = {( {( x - {x}^{′} )}^{2} + {( y - {y}^{′} )}^{2} + {z}^{2} )}^{1 / 2} k = 2 π / λ & ( 1 )\end{matrix}$$

Since the calculation takes time in the state of the integral form of the formula (1), the following formula (2) obtained by converting the formula (1) into a product form of Fourier transform is adopted in this embodiment. Note that in the formula (2), G represents the Fourier transform of g, and u and v represent spatial frequency components in the X direction and the Y direction.

$$\begin{matrix}[ Math . 2 ] & \\ g ( x , y , 0 ) = {F}^{- 1} ( G ( u , v , z ) exp ( - i 2 π w ( u , v ) z ) ) \\ w ( u , v ) = \{ \begin{matrix}{( {λ}^{- 2} - {u}^{2} - {v}^{2} )}^{1 / 2} & {u}^{2} + {v}^{2} \leq {λ}^{- 2} \\ 0 & otherwise\end{matrix} & ( 2 )\end{matrix}$$

As will be described below, the reconfiguration processing unit 63 in this embodiment recalculates, from the complex amplitude distribution of the hologram propagated from the image sensor surface S2 to the support surface Slat a predetermined wavelength, the complex amplitude distribution of the hologram to be propagated from the support surface S1 to the image sensor surface S2 at a wavelength different from the above-mentioned wavelength. Therefore, in this embodiment, a calculation formula in which the formula (2) is replaced with the following formula (3) is adopted.

[Math. 3]

g_{λG}(x,y,z)=F⁻¹{G_{λB}(u,v,z)exp[i2π(w_{G}(u,v)−w_{B}(u,v))z]} (3)

The formula (3) means that the complex amplitude distribution of the hologram g_{λG} to be propagated from the support surface S1 to the image sensor surface S2 at the wavelength λ_{G} is calculated from the complex amplitude distribution of the hologram g_{λB} propagated from the image sensor surface S2 to the support surface S1 at the wavelength λ_{B}.

In this embodiment, the calculation unit 63a repeatedly executes light wave propagation calculation between the sensor surface S2 and the support surface S1 on the basis of the formulae for calculating propagation, i.e., the formulae (2) and (3).

For example, in the case where the amplitude replacement unit 63b does not execute amplitude replacement in the support surface S1, the propagation calculation based on the formula (3) is executed. Meanwhile, in the case of executing amplitude replacement, the complex amplitude distribution of the hologram g_{λG} to be propagated from the support surface S1 to the image sensor surface S2 at the wavelength λ_{G} is calculated on the basis of the formula (2) after replacing the amplitude component of the complex amplitude distribution of the hologram g_{λB} propagated from the image sensor surface S2 to the support surface S1 at the wavelength λ_{B} with a predetermined representative amplitude value.

[Information Processing Method]

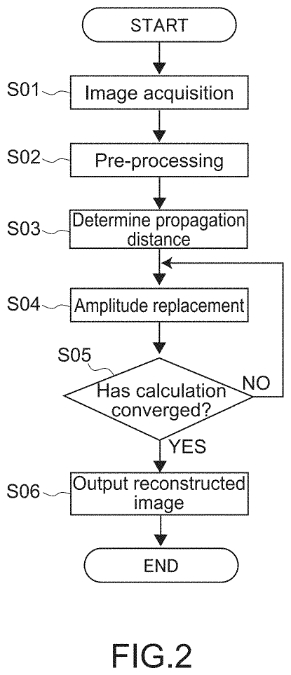

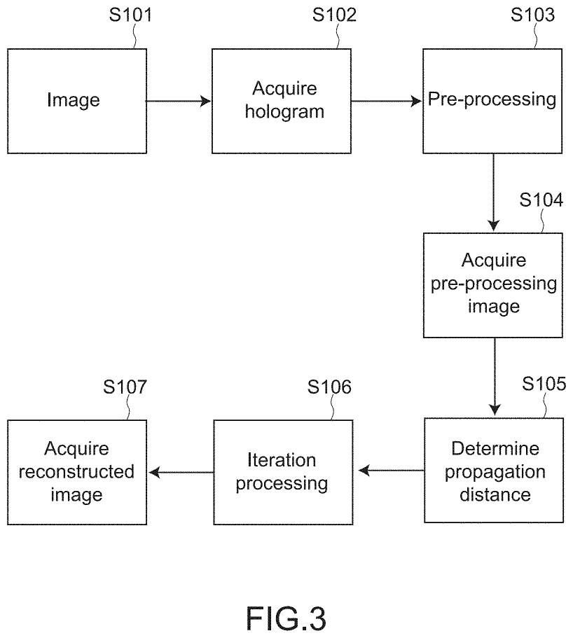

FIG. 2 is a flowchart showing an information processing method for the information processing apparatus 60, and FIG. 3 is a block diagram showing a procedure until the cell observation system 100 acquires a reconstructed image of the cell. Hereinafter, the information processing method for the information processing apparatus 60 will be described with reference to the figures as appropriate.

(Step S01: Image Acquisition)

In Step S01, illumination light of the wavelengths λ_{R}, λ_{G}, and λ_{B} corresponding to RBG, respectively, is individually applied from the light source 10 to the cell C. As a result, the holograms g_{λR}, g_{λG}, and g_{λB} (hologram intensity) corresponding to the wavelengths are individually imaged (S101). The images are recorded on the image sensor surface S2, and image data based on each image is output to the image acquisition unit 61 (S102).

(Step S02: Pre-Processing)

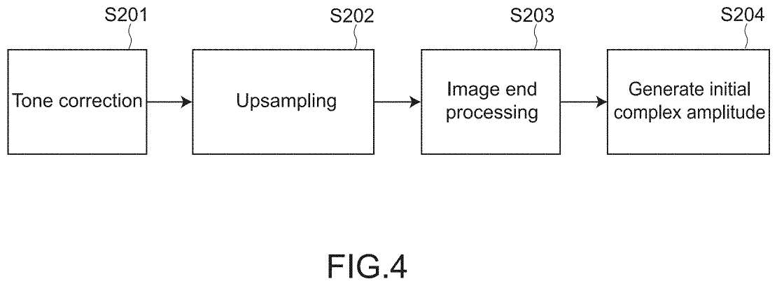

Next, the pre-processing unit 62 performs various types of correction on the image data regarding the holograms g_{λR}, g_{λG}, and g_{λB} output from the image acquisition unit 61 (S103). FIG. 4 a block diagram showing a procedure of pre-processing by the pre-processing unit 62.

First, tone correction (dark level correction, inverse gamma correction) of the image sensor 30 is performed, and the image signals based on the holograms g_{λR}, g_{λG}, and g_{λB} acquired from the image acquisition unit 61 are returned to a linear state (S201). Subsequently, this image signal is upsampled (S202). In the case where the cell observation system 100 according to this embodiment is a lensless microscope, since the resolution of the lensless microscope exceeds the Nyquist frequency of the image sensor 30, it is necessary to perform upsampling in order to exhibit the limit performance.

Subsequently, the edge portions of the holograms g_{λR}, g_{λG}, and g_{λB} are processed (S203). Except for the input value, a boundary condition of zero is applied at the image edge portions, and thus, the condition that is the same as that in which there is a knife edge at the edge portions is obtained. Therefore, diffracted light is generated, which is a factor of new artifacts. In this regard, the number of pixels vertically and horizontally twice the number of pixels of the original image is prepared, and processing of embedding the luminance value of the outermost portion to the outside of the original image disposed at the center is performed. As a result, it is possible to prevent the diffraction fringe generated by the processing on the image edge from affecting the range of the original image.

Subsequently, the real part of the complex amplitude of the light forming the holograms g_{λR}, g_{λG}, and g_{λB} is set to the square root of the pixel value and the imaginary part is set to zero. As a result, initial complex amplitudes relating to the holograms g_{λR}, g_{λG}, and g_{λB} having only the amplitude component are calculated (S204). Note that the above-mentioned pixel value is a processed pixel value processed by the dark level correction (dark subtraction) or the like described above.

Subsequently, the image data based on the holograms g_{λR}, g_{λG}, and g_{λB} on which the above-mentioned pre-processing has been executed by the pre-processing unit 62 is output to the reconfiguration processing unit 63 (S104). Note that the pre-processing of the pre-processing unit 62 is not limited to the above-mentioned method, and another method may be adopted. Further, Step S02 may be omitted as necessary.

(Step S03: Determine Propagation Distance)

Next, the propagation distance (the distance Z between the image sensor surface S2 and the support surface S1) for acquiring a reconstructed image of the cell C is determined (S105).

As a method of determining the propagation distance, it may be determined by digital focusing based on the formula (2) or by the mechanical accuracy of the cell observation system 100. Note that the above-mentioned digital focusing is a method of determining the focal positions of various holograms g_{λR}, g_{λG}, and g_{λB} by adjusting the distance between the image sensor surface S2 and the support surface S1.

In this embodiment, this digital focusing may be manually performed while observing the holograms g_{λR}, g_{λG}, and g_{λB} on the image sensor surface S2, or may be performed by autofocusing.

(Step S04: Amplitude Replacement)

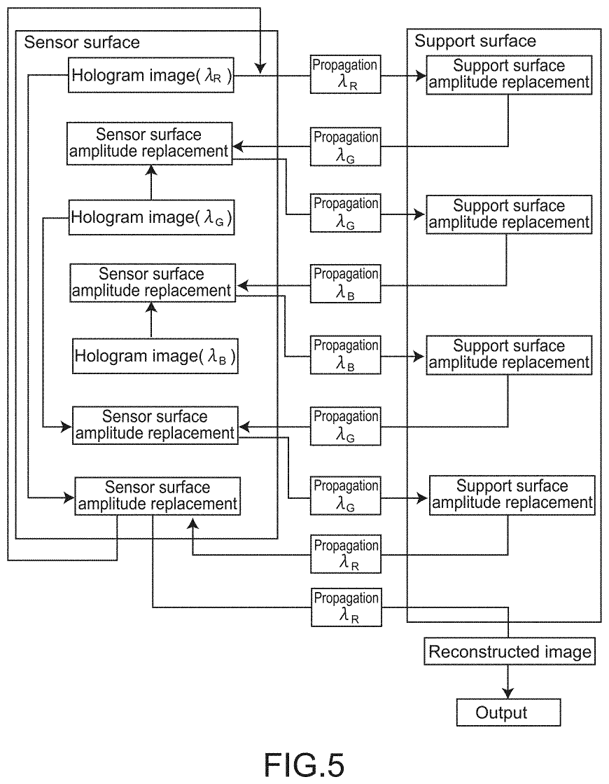

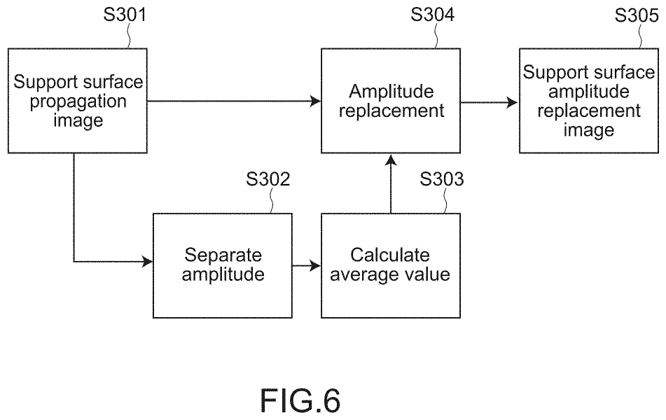

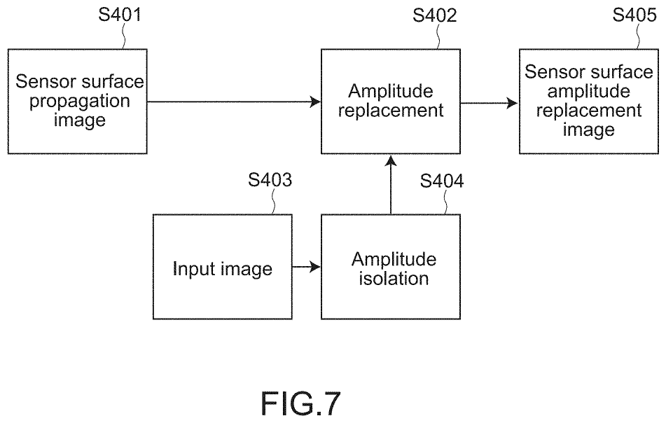

FIG. 5 is a diagram showing calculation processing (algorithm) in iteration in an iterative phase retrieval method executed by the reconfiguration processing unit 63 in this embodiment. Further, FIG. 6 is a block diagram showing a procedure of amplitude replacement processing by the amplitude replacement unit 63b on the support surface S1, and FIG. 7 is a block diagram showing a procedure of amplitude replacement processing by the amplitude replacement unit 63b on the image sensor surface S2.

First, first light wave propagation calculation for propagating, from the image sensor surface S2 to the support surface S1, the complex amplitude distribution (light intensity distribution) of the hologram g_{λR} output from the pre-processing unit 62 is executed (S301).

The complex amplitude distribution of the hologram g_{λR} output from the pre-processing unit 62 is represented by the following formula (4), and the complex amplitude distribution of the hologram g_{λR} propagated to the support surface S1 is represented by the following formula (5).

The complex amplitude distribution of the hologram g_{λR} represented by the following formula (5) is a complex amplitude distribution of the hologram g_{λR} obtained as a result of the above-mentioned first light wave propagation calculation. Note that the complex amplitude distribution of the hologram in this embodiment represents a complex amplitude distribution of light forming the hologram, and the same applies also to the following description.

g_{λR}(x,y,z)=A(x,y,z)exp(iϕ(x,y,z)) (4)
(A(x,y,z): amplitude component, exp(iϕ(x,y,z))
: phase component (arbitrary initial value))

g_{λR}(x,y,0)=A′(x,y,0)exp(iϕ′(x,y,0)) (5)
(A′(x,y,0): amplitude component, exp(iϕ′(x,y,0))
: phase component)

Subsequently, an amplitude component A′ of the complex amplitude distribution relating to the hologram g_{λR} propagated to the support surface S1 at the wavelength λ_{R} is separated (S302), and an average value Aₐᵥₑ of the amplitude component A′ is calculated (S303). Subsequently, the amplitude component A′ of the complex amplitude distribution relating to the hologram g_{λR} is replaced with the average value Aₐᵥₑ on the support surface S1 as part of second light wave propagation calculation described below (S304). This uses, as the restrain condition of the amplitude component, the fact that the amplitude component of the hologram is substantially zero in the case of an object having a high transmittance such as a cell.

As a result, the amplitude component of the complex amplitude distribution in the hologram g_{λR} is smoothed, and the calculation load in the subsequent iterative processing is reduced. The hologram g_{λR} (S305) in which the amplitude component A′ has been replaced with the average value Aₐᵥₑ is represented by the following formula (6).

g_{λR}(x,y,0)=Aₐᵥₑexp(iϕ′(x,y,0))

Aₐᵥₑ=1/N(ΣΣA′(x,y,0)) (6)
(Aₐᵥₑ: amplitude component, exp (iϕ′(x,y,0))
   : phase component, N: total number of pixels)

Note that the average value Aₐᵥₑ in this embodiment is typically an average value of the amplitude component A′ in the complex amplitude distribution (formula (5)) obtained as a result of the above-mentioned first light wave propagation calculation. The average value can be the ratio (integrated average) of the sum of the amplitude component corresponding to each pixel of the hologram g_{λR} (x,y,0) with respect to the number of pixels N of the hologram g_{λR} (x,y,0).

Further, although the amplitude component A′ is replaced with the average value Aₐᵥₑ in the above-mentioned example, the present technology is not limited thereto and is not particularly limited as long as it is a predetermined representative amplitude value in the amplitude component A′ of the complex amplitude distribution (formula (5)) of the hologram g_{λR}.

For example, the amplitude component A′ may be replaced with a median value of the amplitude component A′ other than the average value Aₐᵥₑ, or may be replaced with a low-pass filter transmission component of the amplitude component A′. Alternatively, it may be replaced with the amplitude component of the image acquired in advance in the state where there is no cell C.

Subsequently, the second light wave propagation calculation for propagating the complex amplitude distribution of the hologram g_{λR} in which the amplitude component A′ has been replaced with the average value Aₐᵥₑ from the support surface S1 to the image sensor surface S2 at the wavelength λ_{G} is executed (S401). That is, the complex amplitude distribution of the hologram g_{λG} to be propagated to the image sensor surface S2 at the wavelength λ_{G} is obtained by the propagation calculation from the complex amplitude distribution of the hologram g_{λR} represented by the formula (6). The complex amplitude distribution relating to the hologram g_{λG} is represented by the following formula (7).

g_{λG}(x,y,z)=A″(x,y,z)exp(iϕ″(x,y,z)) (7)
(A″(x,y,z): amplitude component, exp(iϕ″(x,y,z))
: phase component)

Subsequently, the amplitude component A″ of the complex amplitude distribution of the hologram g_{λG} propagated at the wavelength λ_{G} is replaced with an actual measurement value A_{λG} of the amplitude component A″ on the image sensor surface S2 as part of the above-mentioned first light wave propagation calculation (S402). The actual measurement value A_{λG} is an amplitude component (S404) separated from the hologram g_{λG} (S403) obtained under the imaging condition different from the imaging condition in which the hologram g_{λR} has been acquired in the Step S01 above.

In other words, the actual measurement value A_{λG} is an amplitude component of the hologram g_{λG} that is one of a plurality of holograms having wavelengths of illumination light different from that of the hologram g_{λR} acquired in Step S01 above. That is, it is an amplitude component of the hologram g_{λG} recorded on the image sensor surface S2 by applying illumination light of the wavelength λ_{G} to the cell C.

The hologram g_{λG} in which the amplitude component A″ has been replaced with the actual measurement value A_{λG} on the image sensor surface S2 is represented by the following formula (8). As a result, the hologram g_{λG} including the phase component can be acquired.

g_{λG}(x,y,z)=A_{λG}(x,y,z)exp(iϕ″(x,y,z)) (8)
(A_{λG}(x,y,z): amplitude component, exp(iϕ″(x,y,z))
   : phase component)

In this way, a cycle of executing the first light propagation calculation for propagating, from the image sensor surface S2 to the support surface S1, the complex amplitude distribution including the light intensity distribution of the hologram of the cell C acquired on the image sensor surface S2, and executing the second light propagation calculation for propagating, from the support surface S1 to the image sensor surface S2, the complex amplitude distribution obtained as a result of the first light propagation calculation is performed.

In this embodiment, as shown in FIG. 5, iteration in which this cycle is performed on all the holograms g_{λR}, g_{λG}, and g_{λB} is executed, and is executed a predetermined number of times until the calculation converges (NO in S05,S106). The number of times of iteration is not particularly limited, but is favorably approximately 10 to 100 times.

Note that in FIG. 5, the order of the propagation wavelength is Δ_{R}->λ_{G}->λ_{G}->λ_{B}->λ_{B}->λ_{G}->λ_{G}->λ_{R}->λ_{R} in the propagation of the hologram repeated between the image sensor surface S2 and the support surface S1. However, the order is not limited thereto, and may be in random order. For example, the order may be λ_{R}->λ_{B}->λ_{B}->λ_{G}->λ_{G}->λ_{B}->λ_{B}->λ_{R}, λ_{B}->λ_{R}->λ_{R}->λ_{G}->λ_{G}->λ_{R}->λ_{R}->λ_{B}->λ_{B}, or the like. Alternatively, the wavelength to be used may include two wavelengths or four or more wavelengths.

(Step S06: Output of Reconstructed Image)

In the case where the above-mentioned calculation in the iteration has sufficiently converged (YES in S05), a reconstructed image of the cell C is acquired by finally propagating the complex amplitude distribution of the hologram obtained by the amplitude replacement processing in Step S04 to the support surface S1 on the basis of the formula (2).

In Step S05, since the iteration is sufficiently executed in Step S04 above, the phase components of the various holograms g_{λR}, g_{λG}, and g_{λB} of the cell C obtained by applying illumination light of the wavelengths λ_{R}, λ_{B}, and λ_{G} to the cell C are updated as appropriate, and a reconstructed image in which the phase component has been sufficiently retrieved can be acquired (S107). That is, it is possible to reconstruct the sample surface from the defocused holograms g_{λR}, g_{λG}, and g_{λB}.

[Action]

The iterative phase retrieval method in this embodiment uses, as a basic principle, the GS algorithm reported in 1972 by R. W. Gerchberg and W. O. Saxton in the field of electron hologram. This method is a method of retrieving the phase by recording the complex amplitudes of two electron beams on the imaging plane and the defocus plane and repeating propagation between the planes with the measured amplitude values of the two planes as restraint conditions.

This iterative phase retrieval method can also be applied between defocused holograms. That is, a plurality of different holograms can be acquired, and the phase can be retrieved by repeating propagation with the images as restraint conditions.

Here, A. Lambrechts et al. have applied this technology to light waves, have acquired a plurality of holograms obtained by changing the wavelength of illumination light to be caused to enter an object, and have reported that the lost phase component of the hologram can be retrieved by a method of replacing the difference in wavelengths with the difference in propagation distance (hereinafter, existing method) (A. Lambrechts, “Lens-free digital in-line holographic imaging for wide field-of-view, high resolution and real-time monitoring of complex microscopic objects”, Proc. of SPIE, Vol. 8947, 2014).

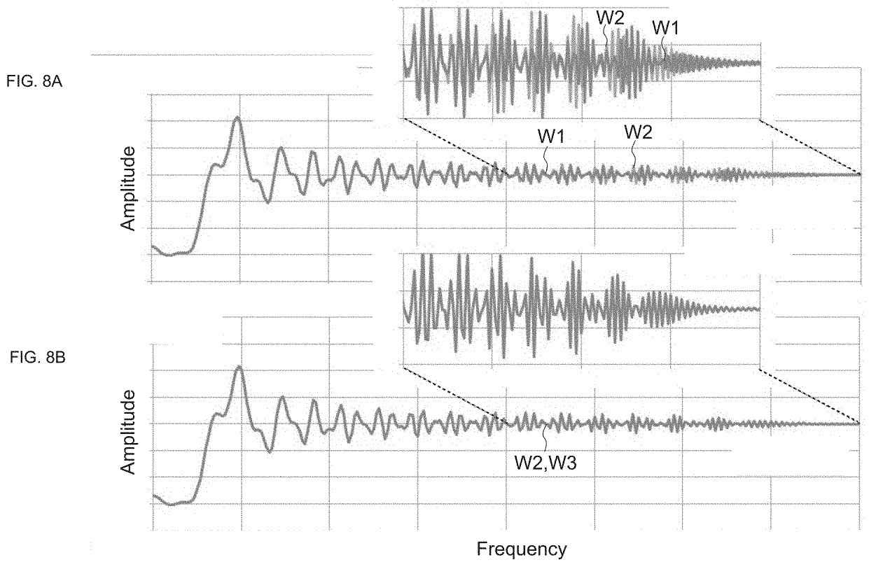

However, in the above-mentioned existing method, for example, in the case where the hologram g_{λG} to be propagated at the wavelength λ_{G} from the hologram g_{λR} imaged at the wavelength λ_{R} is calculated by the propagation calculation based on the formula (2), the hologram waveform of the hologram g_{λG} does not completely match the hologram waveform (correct hologram waveform) of the hologram g_{λG} obtained by simulation in a high frequency region (see part (a) of FIG. 8).

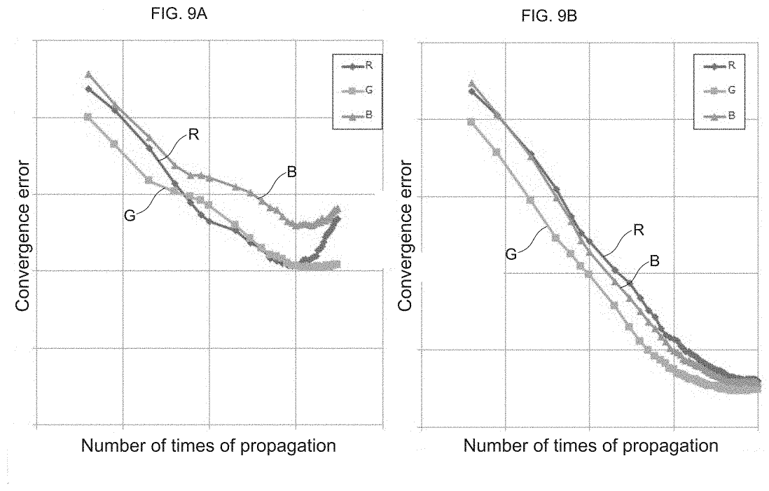

As a result, in the existing method, since an error occurs when replacing the amplitude component of the hologram obtained by calculation with the actual measurement value (hologram obtained by observation) of the amplitude component, there has been a problem that the calculation errors accumulates and it takes time until the iterative processing converges (see part (a) of FIG. 9).

In view of the above, as a result various studies, the present inventers have found the following improvement method for acquiring a reconstructed image of the cell C from the hologram in which the phase component has been lost. Hereinafter, the improvement method will be described step by step.

(Improvement Method 1)

Part (a) of FIG. 8 is a graph in which a hologram waveform W1 (amplitude waveform) of the hologram g_{λG} of the wavelength λ_{G} obtained by propagation calculation of the hologram g_{λR} having a known phase at the wavelength λ_{R} and a hologram waveform W2 (correct amplitude waveform) of the hologram g_{λG} obtained by simulation are superimposed on the basis of the existing method.

Meanwhile, Part (b) of FIG. 8 is a graph in which a hologram waveform W3 (amplitude waveform) of the hologram g_{λG} of the wavelength λ_{G} obtained by propagation calculation of the hologram g_{λR} having a known phase at the wavelength λ_{R} and the hologram waveform W2 (correct amplitude waveform) of the hologram g_{λG} obtained by simulation are superimposed on the basis of the formula (3).

Further, Part (a) of FIG. 9 is a graph showing a relationship between the number of times of propagation between the object surface and the sensor surface and the convergence error in the existing method, and Part (b) of FIG. 9 is a graph showing a relationship of the number of times of propagation between the support surface S1 and the image sensor surface S2 and the convergence error in the iterative phase retrieval method in this embodiment.

As shown in Part (b) of FIG. 8, the hologram waveform W3 of the hologram g_{λG} calculated on the basis of the formula (3) completely matches the hologram waveform W2 of the hologram g_{λG} obtained by simulation also in a high frequency region unlike the existing method.

Therefore, in the iterative phase retrieval method in this embodiment, since an error is less likely to occur when replacing the amplitude component of the calculated hologram with the actual measurement value of the amplitude component, the iterative processing converges faster than that in the existing method. This is apparent also from the result shown in Part (b) of FIG. 9. As a result, it is possible to reduce the number of times of iteration necessary for retrieving the phase as compared with the case of the existing method and reduce the processing time.

(Improvement Method 2)

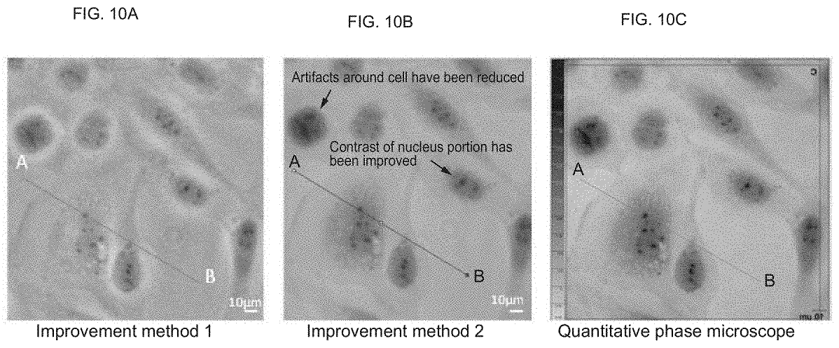

However, in the improvement method 1 (see the formula (3)) of performing the propagation calculation in which after propagating the hologram recorded on the image sensor surface S2 to the support surface S1 (position Z=0) once, the hologram propagated to the support surface S1 is propagated to the image sensor surface S2 again, the calculation error existing in the high frequency component is eliminated and the convergence is improved, but it is difficult to remove the low frequency artifacts of the reconstructed image in actual measurement (see Part (a) of FIG. 10).

In view of the above, in this embodiment, the improvement method 2 in which the amplitude component of the complex amplitude component in the hologram propagated to the support surface S1 is replaced with the average value of the amplitude component in the propagation calculation introduced in the improvement method 1 has been introduced (see Step S04).

This makes it possible to reduce the low frequency artifacts existing around the cell (see Part (b) of FIG. 10). In the example of Part (b) of FIG. 10, it can be seen that the contrast in a portion having a phase difference, such as a nucleus, has been improved and the artifacts around the cell have been reduced.

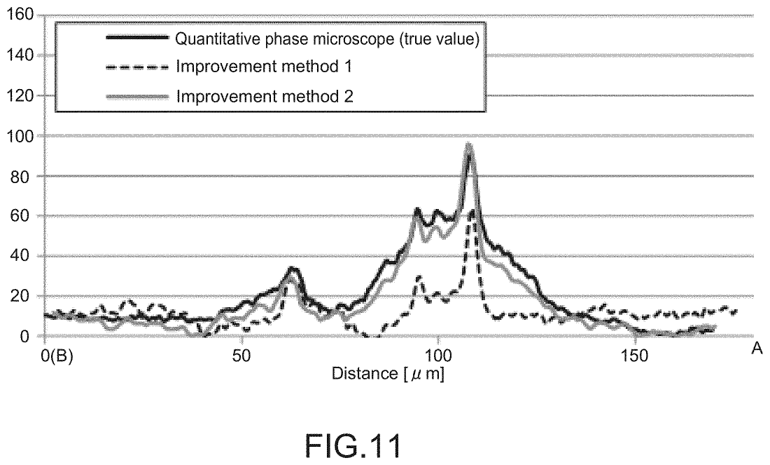

FIG. 10 is a diagram showing reconstructed images of the cell acquired by the improvement methods 1 and 2 and an image in which the cell is imaged by a microscope (quantitative phase microscope) capable of measuring the phase value. Further, FIG. 11 is a graph showing phase values between arbitrary two points A and B of the images. In FIG. 10 and FIG. 11, the measurement result by the quantitative phase microscope is used as true values, and the improvement methods 1 and 2 are compared with each other and shown.

Referring to FIG. 11, it can be seen that the phase value obtained by the improvement method 2 is clearly close to the true value than that by the improvement method 1. Note that the mean square error of the phase value in the improvement method 1 is 12.8 deg as compared with the true value, and the mean square error of the phase value in the improvement method 2 is 4.3 deg as compared with the true value.

### Second Embodiment

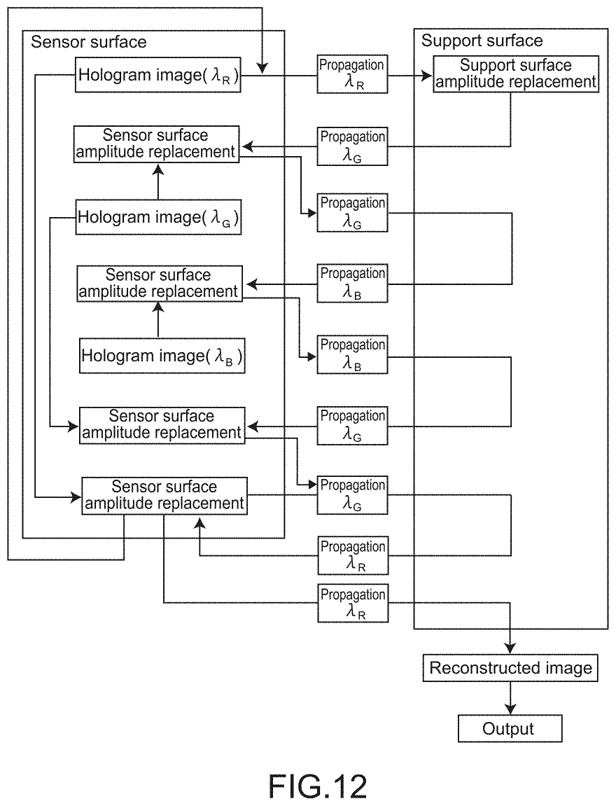

FIG. 12 is a diagram showing calculation processing (algorithm) in iteration in the iterative phase retrieval method executed by the reconfiguration processing unit 63 in a second embodiment of the present technology. Hereinafter, description of Steps similar to those in the first embodiment will be omitted.

In this embodiment, as shown in FIG. 12, the amplitude component of the complex amplitude distribution determined on the basis of the above-mentioned first light wave propagation calculation is replaced with a predetermined representative amplitude value of the amplitude component every time the iteration is performed.

In this case, in the example shown in FIG. 12, smoothing of the amplitude component A′ is achieved by replacing the amplitude component A′ (see the formula (5)) of the hologram g_{λR} obtained on the basis of the first light wave propagation calculation for propagating the complex amplitude distribution of the hologram g_{λR} from the image sensor surface S2 to the support surface S1 at the wavelength λ_{R} with, for example, the average value Aₐᵥₑ of the amplitude component A′. As a result, the calculation errors that occur by the repeated amplitude replacement processing on the support surface S1 are prevented from accumulating, and new artifacts that should not have existed are prevented from occurring in a reconstructed image.

### Third Embodiment

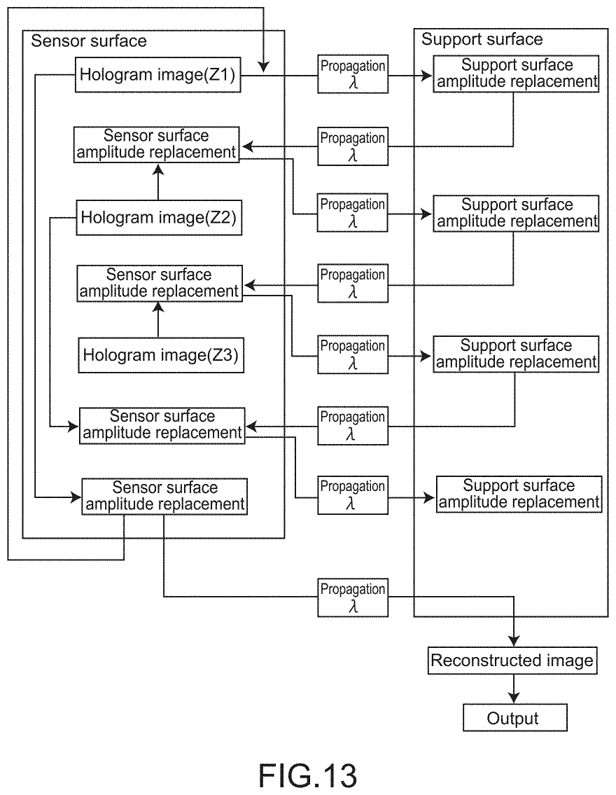

FIG. 13 is a diagram showing calculation processing (algorithm) in iteration in the iterative phase retrieval method executed by the reconfiguration processing unit 63 in a third embodiment of the present technology. Hereinafter, description of Steps similar to those in the first embodiment will be omitted.

In the iterative phase retrieval method in this embodiment, the phase component of the hologram lost on the image sensor surface S2 is retrieved by repeating propagation between the image sensor surface S2 and the support surface S1 with the various holograms g_{Z1}, g_{Z2}, and g_{Z3} individually acquired by the image sensor 30 at the arbitrary positions Z1, Z2, and Z3 having different distances from the support surface S1 as the restraint condition. Hereinafter, details thereof will be described.

(Step S01: Image Acquisition)

In Step S01, by applying illumination light having the predetermined wavelength λ to the cell C, on the image sensor surface S2 at the arbitrary different positions Z1, Z2, and Z3 with respect to the cell C, the holograms g_{Z1}, g_{A2}, and g_{Z3} (hologram intensity) corresponding to the positions are individually recorded. The image data based on each of the images is output to the image acquisition unit 61.

(Step S04: Amplitude Replacement)

First, the first light wave propagation calculation for propagating, from the image sensor surface S2 to the support surface S1, the complex amplitude distribution (light intensity distribution) of the hologram g_{Z1} recorded on the image sensor surface S2 at the first position Z1 with respect to the cell C is executed. The complex amplitude distribution of the hologram g_{Z1} recorded on the image sensor surface S2 is represented by the following formula (9), and the complex amplitude distribution of the hologram g_{Z1} propagated to the support surface S1 is represented by the following formula (10).

The complex amplitude distribution of the hologram g_{Z1} represented by the following formula (10) is a complex amplitude distribution of the hologram g_{Z1} obtained as a result of the above-mentioned first light wave propagation calculation.

g_{Z1}(x,y,z)=A(x,y,z)exp(iϕ(x,y,z)) (9)
(A (x,y,z): amplitude component, exp(iϕ(x,y,z))
: phase component (arbitrary initial value))

g_{Z1}(x,y,0)=A′(x,y,0)exp(iϕ′(x,y,0)) (10)
(A′(x,y,0): amplitude component, exp(iϕ′(x,y,0))
: phase component)

Subsequently, the amplitude component A′ of the complex amplitude distribution relating to the hologram g_{Z1} propagated to the support surface S1 at the wavelength λ is replaced with the average value Aₐᵥₑ on the support surface S1 as part of the second light wave propagation calculation described below. The complex amplitude distribution of the hologram g_{Z1} in which the amplitude component A′ has been replaced with the average value Aₐᵥₑ is represented by the following formula (11).

g_{Z1}(x,y,0)=Aₐᵥₑexp(iϕ′(x,y,0))

Aₐᵥₑ=1/N(ΣΣA′(x,y,0)) (11)
(Aₐᵥₑ amplitude component, exp (iϕ′(x,y,0))
   : phase component, N: total number of pixels)

Note that the average value Aₐᵥₑ in this embodiment is typically an average value of the amplitude component A′ in the complex amplitude distribution (formula (10)) obtained as a result of the above-mentioned first light wave propagation calculation. Further, although the amplitude component A′ is replaced with the average value Aₐᵥₑ in the above-mentioned example, the present technology is not limited thereto and is not particularly limited as long as it is a predetermined representative amplitude value in the amplitude component A′ of the complex amplitude distribution (formula (10)) of the hologram g_{Z1}.

Subsequently, the second light wave propagation calculation for propagating the complex amplitude distribution of the hologram g_{Z1} in which the amplitude component A′ has been replaced with the average value Aₐᵥₑ from the support surface S1 to the image sensor surface S2 at the second position Z2 with respect to the cell C at the wavelength λ is executed. That is, the complex amplitude distribution of the hologram g_{Z2} to be propagated to the image sensor surface S2 at the wavelength λ at the second position Z2 is obtained from the complex amplitude distribution of the hologram g_{Z1} represented by the following formula (11) by propagation calculation. The complex amplitude distribution relating to the hologram g_{Z2} is represented by the following formula (12).

g_{Z2}(x,y,z)=A″(x,y,z)exp(iϕ″(x,y,z)) (12)
(A″(x,y,z): amplitude component, exp (iϕ″ (x,y,z))
: phase component)

Subsequently, the amplitude component A″ of the complex amplitude distribution of the hologram g_{Z2} propagated at the wavelength λ is replaced with an actual measurement value A_{Z2} of the amplitude component A″ on the image sensor surface S2 as part of the above-mentioned first light wave propagation calculation. The actual measurement value A_{Z2} is an amplitude component of the complex amplitude distribution relating to the hologram g_{Z2} obtained under the imaging condition different from that imaging condition in which the hologram g_{Z1} has been acquired in Step S01 above.

In other words, the actual measurement value A_{Z2} is an amplitude component of the hologram g_{Z2} that is one of the plurality of holograms having distances from the support surface S1 different from that of the hologram g_{Z1} acquired in Step S01 above. That is, the actual measurement value A_{Z2} is an amplitude component of the hologram g_{Z2} recorded at the second position Z2 in Step S01 above.

The hologram g_{Z2} in which the amplitude component A″ has been replaced with the actual measurement value A_{Z2} on the image sensor surface S2 is represented by the following formula (13). As a result, the hologram g_{Z2} having a phase component can be acquired.

g_{Z2}(x,y,z)=A_{Z2}(x,y,z)exp(iϕ″(x,y,z)) (13)
(A_{Z2}(x,y,z): amplitude component, exp(iϕ″(x,y,z))
   : phase component)

In this way, a cycle of executing the first light propagation calculation for propagating, from the image sensor surface S2 to the support surface S1, the complex amplitude distribution including a light intensity distribution of the hologram of the cell C acquired on the image sensor surface S2, and executing the second light propagation calculation for propagating, from the support surface S1 to the image sensor surface S2, the complex amplitude distribution obtained as a result of the first light propagation calculation is performed.

In this embodiment, as shown in FIG. 13, iteration in which this cycle is performed on all the holograms g_{Z1}, g_{Z2}, and g_{Z3} that have been individually recorded in the image sensor 30 at the respective positions Z1, Z2, and Z3 with respect to the cell C is executed, and is executed a predetermined number of times until the calculation converges (NO in S05).

(Step S06: Output of Reconstructed Image)

In the case where the above-mentioned calculation in the iteration has sufficiently converged (YES in S05), a reconstructed image of the cell C is acquired by finally propagating the complex amplitude distribution of the hologram obtained by the amplitude replacement processing in Step S04 to the support surface S1 on the basis of the formula (2)

In Step S06, since the iteration is sufficiently executed in Step S04 above, the phase components of the various holograms g_{Z1}, g_{Z2}, and g_{Z3} that have been individually recorded in the image sensor 30 at the respective positions Z1, Z2, and Z3 with respect to the cell C are updated as appropriate, and a reconstructed image in which the phase component has been sufficiently retrieved can be acquired. That is, it is possible to reconstruct the sample surface from the defocused holograms g_{Z1}, g_{Z2}, and g_{Z3}.

Although embodiments of the present technology have been described above, it goes without saying that the present technology is not limited to the above-mentioned embodiments and various modifications can be made.

For example, all the amplitude components of the pixels of the hologram are replaced with average values in the above-mentioned embodiments. However, the present technology is not limited thereto, and the amplitude replacement unit 63b may be configured to be capable of adjusting the ratio of replacing the amplitude component with the average value. In this case, the complex amplitude distribution of the hologram is represented by the following formula (14). Note that α is a correction coefficient.

g(x,y,0)={(1−α)A(x,y,0)+αAₐᵥₑ}exp(iϕ′(x,y,0)) (14)
((1−α)A(x,y,0)+αAₐᵥₑ amplitude component,
exp (iϕ′(x,y,0)): phase component, 0≤α≤1)

Alternatively, the amplitude component of the complex amplitude distribution of the hologram may include a value obtained by multiplying the average value by a predetermined correction coefficient β, and the predetermined correction coefficient β may be changed in accordance with the number of times the above-mentioned second light wave propagation calculation is executed. In this case, the complex amplitude distribution of the hologram is represented by the following formula (15).

g(x,y,0)={(1−β(n))A(x,y,0)+β(n)Aₐᵥₑ}exp(iϕ′(x,y,0)) (15)
((1−β(n))A(x,y,0)+β(n)Aₐᵥₑ: amplitude component,
exp(iϕ′(x,y,0)): phase component, 0≤β≤1)

Alternatively, the amplitude component of the complex amplitude distribution of the hologram may include a value obtained by multiplying the average value by a predetermined correction coefficient γ, and the correction coefficient γ may differ for each pixel region. In this case, the complex amplitude distribution of the hologram is represented by the following formula (16).

g(x,y,0)={(1−γ(x,y,0))A(x,y,0)+γ(x,y,0)Aₐᵥₑ}exp(iϕ′(x,y,0)) (16)
((1−γ(x,y,0))A+γ(x,y,0)Aₐᵥₑ: amplitude component,
exp(iϕ′(x,y,0)): phase component, 0≤γ≤1)

In addition, instead of replacing the amplitude component of the complex amplitude distribution of the hologram with the average value, a band pass filter or the like may be applied.

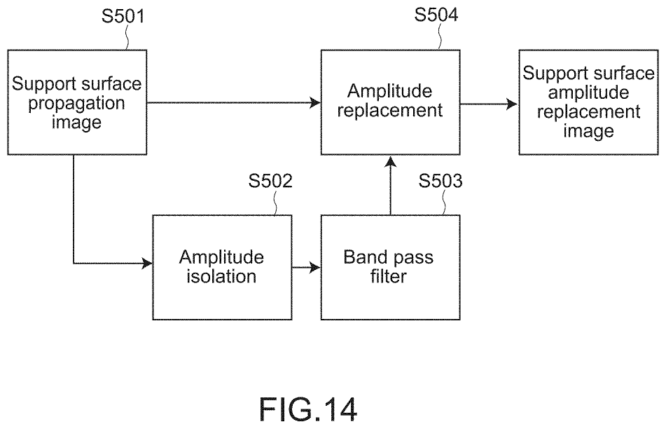

FIG. 14 is a block diagram showing a procedure of amplitude replacement processing by the amplitude replacement unit 63b on the support surface S1. Specifically, the amplitude component of the complex amplitude distribution relating to the hologram g (S501) propagated to the support surface S1 is isolated (S502), and the spatial frequency band of the amplitude component is removed (S503). Then, the amplitude component of the complex amplitude distribution relating to the hologram g may be replaced with the amplitude component from which the spatial frequency component has been removed (S504).

Further, although the amplitude replacement unit 63b replaces the amplitude component of the complex amplitude distribution of the hologram with a predetermined representative amplitude value for each cycle in which the hologram is propagated from the image sensor surface S2 to the support surface S1 and from the support surface S1 to the image sensor surface S2 in the first embodiment, the present technology is not limited thereto.

For example, the amplitude replacement unit 63b may replace the amplitude component with the representative amplitude value every other cycle in the process of executing iteration one time, or may replace the amplitude component with the representative amplitude value for every multiple cycles.

Further, although the amplitude replacement unit 63b replaces the amplitude component of the complex amplitude distribution of the hologram with the predetermined representative amplitude value every time the iteration is performed in the second embodiment, the present technology is not limited thereto.

For example, the amplitude replacement unit 62b may replace the amplitude component with the representative amplitude value every time the iteration is executed twice, or may replace the amplitude component with the representative amplitude value every time the iteration is executed a plurality of times.

It should be noted that the present technology may take the following configurations.

(1)

An information processing apparatus, including:

a calculation unit that repeatedly executes first light propagation calculation for propagating, from a sensor surface of an image sensor to a support surface that supports a cell to be observed, a first complex amplitude distribution that includes a light intensity distribution of a hologram of the cell obtained on the sensor surface, and second light propagation calculation for propagating, from the support surface to the sensor surface, a second complex amplitude distribution obtained as a result of the first light propagation calculation; and

an amplitude replacement unit that replaces, in the second light propagation calculation, an amplitude component of the second complex amplitude distribution with a predetermined representative amplitude value at least once.

(2)

The information processing apparatus according to (1) above, in which

the amplitude replacement unit replaces an amplitude component of the first complex amplitude distribution with an amplitude component of a different hologram acquired under a different imaging condition every time the first light propagation calculation is executed.

(3)

The information processing apparatus according to (2) above, in which

the different hologram is one of a plurality of holograms having different wavelengths of the illumination light.

(4)

The information processing apparatus according to (2) above, in which

the different hologram is one of a plurality of holograms having different distances from the support surface.

(5)

The information processing apparatus according to any one of (1) to (4) above, in which

the amplitude replacement unit replaces the amplitude component of the second complex amplitude distribution with the predetermined representative amplitude value every time the second light propagation calculation is executed.

(6)

The information processing apparatus according to according to any one of (1) to (5) above, in which

the predetermined representative amplitude value is an average value of complex amplitude distributions obtained as results of the first light propagation calculation.

(7)

The information processing apparatus according to according to (6) above, in which

the predetermined representative amplitude value includes a value obtained by multiplying the average value by a predetermined correction coefficient, and

the amplitude replacement unit causes the correction coefficient to differ for each pixel region.

(8)

The information processing apparatus according to (6) above, in which

the predetermined representative amplitude value includes a value obtained by multiplying the average value by a predetermined correction coefficient, and

the amplitude replacement unit causes the correction coefficient to differ every time the second light propagation calculation is executed.

(9)

An information processing method, including:

repeatedly executing first light propagation calculation for propagating, from a sensor surface of an image sensor to a support surface that supports a cell to be observed, a first complex amplitude distribution that includes a light intensity distribution of a hologram of the cell obtained on the sensor surface, and second light propagation calculation for propagating, from the support surface to the sensor surface, a second complex amplitude distribution obtained as a result of the first light propagation calculation; and

replacing, in the second light propagation calculation, an amplitude component of the second complex amplitude distribution with a predetermined representative amplitude value at least once.

(10)

A program that causes an information processing apparatus to execute the steps of:

repeatedly executing first light propagation calculation for propagating, from a sensor surface of an image sensor to a support surface that supports a cell to be observed, a first complex amplitude distribution that includes a light intensity distribution of a hologram of the cell obtained on the sensor surface, and second light propagation calculation for propagating, from the support surface to the sensor surface, a second complex amplitude distribution obtained as a result of the first light propagation calculation; and

replacing, in the second light propagation calculation, an amplitude component of the second complex amplitude distribution with a predetermined representative amplitude value at least once.

(11)

A cell observation system, including:

a light source that emits illumination light;

a sample holder having a support surface that supports a cell to be observed;

an image sensor having a sensor surface that receives a hologram generated by interference between transmitted light and diffracted light, the illumination light being separated by the cell into the transmitted light and the diffracted light; and

a reconfiguration processing unit that
repeatedly executes first light propagation calculation for propagating, from the sensor surface to the support surface, a first complex amplitude distribution that includes a light intensity distribution of the hologram obtained on the sensor surface, and second light propagation calculation for propagating, from the support surface to the sensor surface, a second complex amplitude distribution obtained as a result of the first light propagation calculation, and
replaces, in the second light propagation calculation, an amplitude component of the second complex amplitude distribution with a predetermined representative amplitude value at least once.

### REFERENCE SIGNS LIST

100 cell observation system
10 light source
20 observation stage
30 image sensor
60 information processing apparatus
61 image acquisition unit
62 pre-processing unit
63 reconfiguration processing unit
63a calculation unit
63b amplitude replacement unit
C cell
S1 support surface
S2 image sensor surface
H sample holder

1. An information processing apparatus, comprising:
a calculation unit that repeatedly executes first light propagation calculation for propagating, from a sensor surface of an image sensor to a support surface that supports a cell to be observed, a first complex amplitude distribution that includes a light intensity distribution of a hologram of the cell obtained on the sensor surface, and second light propagation calculation for propagating, from the support surface to the sensor surface, a second complex amplitude distribution obtained as a result of the first light propagation calculation; and
an amplitude replacement unit that replaces, in the second light propagation calculation, an amplitude component of the second complex amplitude distribution with a predetermined representative amplitude value at least once.

2. The information processing apparatus according to claim 1, wherein
the amplitude replacement unit replaces an amplitude component of the first complex amplitude distribution with an amplitude component of a different hologram acquired under a different imaging condition every time the first light propagation calculation is executed.

3. The information processing apparatus according to claim 2, wherein
the different hologram is one of a plurality of holograms having different wavelengths of the illumination light.

4. The information processing apparatus according to claim 2, wherein
the different hologram is one of a plurality of holograms having different distances from the support surface.

5. The information processing apparatus according to claim 1, wherein
the amplitude replacement unit replaces the amplitude component of the second complex amplitude distribution with the predetermined representative amplitude value every time the second light propagation calculation is executed.

6. The information processing apparatus according to claim 1, wherein
the predetermined representative amplitude value is an average value of complex amplitude distributions obtained as results of the first light propagation calculation.

7. The information processing apparatus according to claim 6, wherein
the predetermined representative amplitude value includes a value obtained by multiplying the average value by a predetermined correction coefficient, and
the amplitude replacement unit causes the correction coefficient to differ for each pixel region.

8. The information processing apparatus according to claim 6, wherein
the predetermined representative amplitude value includes a value obtained by multiplying the average value by a predetermined correction coefficient, and
the amplitude replacement unit causes the correction coefficient to differ every time the second light propagation calculation is executed.

9. An information processing method, comprising:
repeatedly executing first light propagation calculation for propagating, from a sensor surface of an image sensor to a support surface that supports a cell to be observed, a first complex amplitude distribution that includes a light intensity distribution of a hologram of the cell obtained on the sensor surface, and second light propagation calculation for propagating, from the support surface to the sensor surface, a second complex amplitude distribution obtained as a result of the first light propagation calculation; and
replacing, in the second light propagation calculation, an amplitude component of the second complex amplitude distribution with a predetermined representative amplitude value at least once.

10. A program that causes an information processing apparatus to execute the steps of:
repeatedly executing first light propagation calculation for propagating, from a sensor surface of an image sensor to a support surface that supports a cell to be observed, a first complex amplitude distribution that includes a light intensity distribution of a hologram of the cell obtained on the sensor surface, and second light propagation calculation for propagating, from the support surface to the sensor surface, a second complex amplitude distribution obtained as a result of the first light propagation calculation; and
replacing, in the second light propagation calculation, an amplitude component of the second complex amplitude distribution with a predetermined representative amplitude value at least once.

11. A cell observation system, comprising:
a light source that emits illumination light;
a sample holder having a support surface that supports a cell to be observed;
an image sensor having a sensor surface that receives a hologram generated by interference between transmitted light and diffracted light, the illumination light being separated by the cell into the transmitted light and the diffracted light; and
a reconfiguration processing unit that
repeatedly executes first light propagation calculation for propagating, from the sensor surface to the support surface, a first complex amplitude distribution that includes a light intensity distribution of the hologram obtained on the sensor surface, and second light propagation calculation for propagating, from the support surface to the sensor surface, a second complex amplitude distribution obtained as a result of the first light propagation calculation, and
replaces, in the second light propagation calculation, an amplitude component of the second complex amplitude distribution with a predetermined representative amplitude value at least once.
